(19) United States
(12) Patent Application Publication
(10) Pub. No.: US 2015/0371203 A1
(43) Pub. Date: Dec. 24, 2015

(54) MEDICAL BILLING USING A SINGLE WORKFLOW TO PROCESS MEDICAL BILLING CODES FOR TWO OR MORE CLASSES OF REIMBURSEMENT

(71) Applicant: 3M INNOVATIVE PROPERTIES COMPANY, Saint Paul, MN (US)

(72) Inventors: Cathy L Plunkett, Kennesaw, GA (US); Michael S Bee, Salt Lake City, UT (US); Marcus T Brown, Draper, UT (US); Kim A Cobler, Salt Lake City, UT (US)

(21) Appl. No.: 14/765,040

(22) PCT Filed: Jan. 20, 2014
(86) PCT No.: PCT/US2014/012192

§ 371 Date: Jul. 31, 2015

Related U.S. Application Data
(60) Provisional application No. 61/759,572, filed on Feb. 1, 2013.

(51) Int. Cl. G06Q 20/14; G06Q 50/22; G06F 19/00

(52) U.S. Cl. CPC G06Q 20/14; G06F 19/328; G06Q 50/22

(57) ABSTRACT

In one example, this disclosure describes a method of processing medical data via one or more computers. The method may comprise receiving patient encounter data describing a patient encounter with a healthcare organization. The method may further comprise determining, one or more facility reimbursement facts and one or more professional reimbursement facts based on the patient encounter data. After determined reimbursement facts, the method may include outputting a user interface including a listing of the determined facility reimbursement facts and a listing of the determined professional reimbursement facts. The method may also include receiving selection input associated with the facility reimbursement facts and the professional reimbursement facts and an indication that the facility reimbursement facts and the professional reimbursement facts are finalized.

### TECHNICAL FIELD

The invention relates to medical billing for facility and professional services.

### BACKGROUND

In the medical field, accurate processing of patient visits to hospitals and clinics for reimbursement by insurers or other medical payers is important to ensure that medical professionals and facilities receive payment in a timely manner. The emergence of integrated health systems where doctors are employed directly by the hospitals and clinics presents challenges for integrating the processing of patient visits for reimbursement of both facility and physician services.

### SUMMARY

This disclosure describes systems and techniques for processing medical data via one or more computers. The techniques and systems described herein can help to automate (or partially automate) a process of verifying and updating reimbursement facts associated with patient encounter data. In this manner, the process can be improved and/or simplified. Further, the described techniques and systems may integrate one or more steps taken by a medical reviewer (sometimes referred to as a “documentation specialist”), which may further improve and/or simplify the process for reviewing and adjusting the assignment of reimbursement facts to patient encounter data.

In one example, this disclosure describes a method of processing medical data via one or more computers. The method comprises receiving, at the one or more computers, patient encounter data describing a patient encounter with a healthcare organization, determining, via the one or more computers, one or more facility reimbursement facts based on the patient encounter data, determining, via one or more computers, one or more professional reimbursement facts based on the patient encounter data, outputting a user interface including a listing of the determined facility reimbursement facts and a listing of the determined professional reimbursement facts, receiving, at the one or more or more computers, selection input associated with the facility reimbursement facts and the professional reimbursement facts, and receiving, at the one or more computers, an indication that the facility reimbursement facts and the professional reimbursement facts are finalized.

In another example, this disclosure describes a computerized medical system for processing medical data, the system comprising a computer that includes a processor and a memory, wherein the processor is configured to receive patient encounter data describing a patient encounter with a healthcare organization, determine one or more facility reimbursement facts based on the patient encounter data, determine one or more professional reimbursement facts based on the patient encounter data, output a user interface including a listing of the determined facility reimbursement facts and a listing of the determined professional reimbursement facts, receive selection input associated with the facility reimbursement facts and the professional reimbursement facts, and receive an indication that the facility reimbursement facts and the professional reimbursement facts are finalized.

In another example, this disclosure describes a device for processing medical data. In this example, the device comprises a means for receiving patient encounter data describing a patient encounter with a healthcare organization, means determining one or more facility reimbursement facts based on the patient encounter data, means determining one or more professional reimbursement facts based on the patient encounter data, means for outputting a user interface including a listing of the determined facility reimbursement facts and a listing of the determined professional reimbursement facts, means for receiving selection input associated with the facility reimbursement facts and the professional reimbursement facts, means for receiving an indication that the facility reimbursement facts and the professional reimbursement facts are finalized.

The techniques of this disclosure may be implemented at least partially in hardware, such as a processor or discrete logic circuits. The techniques may also be implemented using aspects of software or firmware in combination with the hardware. If implemented at least partially in software or firmware, the software or firmware may be executed in one or more hardware processors, such as a microprocessor, application specific integrated circuit (ASIC), field programmable gate array (FPGA), or digital signal processor (DSP). The software that executes the techniques may be initially stored in a computer-readable storage medium and loaded and executed in the processor. The processor may execute modules to perform the techniques of this disclosure, and the modules may comprise combinations of software and hardware, e.g., software routines executing on the processor.

Accordingly, this disclosure also contemplates a computer-readable storage medium comprising instructions that when executed in a processor cause the processor to process medical data, wherein upon execution, the instructions cause the processor to receive patient encounter data describing a patient encounter with a healthcare organization, determine one or more facility reimbursement facts based on the patient encounter data, determine one or more professional reimbursement facts based on the patient encounter data, output a user interface including a listing of the determined facility reimbursement facts and a listing of the determined professional reimbursement facts, receive selection input associated with the facility reimbursement facts and the professional reimbursement facts, receive an indication that the facility reimbursement facts and the professional reimbursement facts are finalized.

The details of one or more embodiments of the invention are set forth in the accompanying drawings and the description below. Other features, objects, and advantages of the invention will be apparent based on the description and drawings, and based on the claims.

### BRIEF DESCRIPTION OF DRAWINGS

FIG. 1 is a block diagram illustrating an example of a stand alone computer system for coding medical data consistent with this disclosure.

FIG. 2 is a block diagram illustrating an example of a distributed system for coding medical data consistent with this disclosure.

FIG. 3 is a diagram illustrating an example user interface window including a listing of patient records containing patient encounter data.

FIG. 4 is a diagram illustrating a user interface window including a listing of the patient encounter data, facility reimbursement facts, and professional reimbursement facts.

FIG. 5 is a diagram illustrating a user interface window including a listing of the patient encounter data, reimbursement facts common to both facility and professional reimbursement, and separate facility reimbursement facts.

FIG. 6 is a diagram illustrating a user interface window including a listing of the patient encounter data, reimbursement facts common to both facility and professional reimbursement, and separate professional reimbursement facts.

FIGS. 7-8 are exemplary computer screen shots that may illustrate one or more features of this disclosure.

FIG. 9 is a flow diagram illustrating a technique of this disclosure.

FIG. 10 is a flow diagram illustrating a technique of this disclosure.

### DETAILED DESCRIPTION

This disclosure describes systems and techniques for processing medical data via one or more computers. The systems and techniques may be used by a medical reviewer (sometimes referred to as a “documentation specialist”). The documentation specialist may be assigned the task of reviewing patient encounter data, such as medical records or other documentation detailing a patient encounter with a healthcare organization, for purposes of billing a payer and ensuring accuracy in the patient encounter data. The payer may be a governmental agency, such a Medicare or Medicaid, or a private entity, such as an insurance company. The documentation specialist may be a nurse, clinician, administrative person, or any person given the task of reviewing the patient encounter data, and verifying or updating reimbursement facts in the documentation. In general, the documentation specialist typically reviews the patient encounter data and ensures that the data include the correct reimbursement facts associated with the medical tasks or medical conditions defined in the data.

In some instances more than one documentation specialist may review the patient encounter data and verify or update reimbursement facts. For instance, one documentation specialist may review the patient encounter data and verify or update reimbursement facts associated with facility reimbursement while another documentation specialist may verify or update the reimbursement facts associated with professional reimbursement. As another complication to this updating and verification process, some of the reimbursement facts are used for both facility and professional reimbursement. Having multiple documentation specialists reviewing and updating reimbursement facts may result in inconsistencies between the reimbursement facts submitted for facility reimbursement and the reimbursement facts submitted for professional reimbursement. These inconsistencies may result in delayed payment for performed services and equipment use, which in turn may require increased resources necessary to sort out.

The techniques and systems described herein can help to simplify the updating and verification process described herein and reduce the incidence of inconsistencies in finalized lists of facility reimbursement facts and professional reimbursement facts. The techniques may operate to reduce the number of documentation specialists that verify or update reimbursement facts in the patient encounter data associated with any single patient encounter. In this manner, a single documentation specialist may verify or update the reimbursement facts associated with both facility and professional reimbursement for a single patient encounter, thereby reducing the incidence of inconsistencies between the facility and professional reimbursement facts. The techniques may further describe methods and systems for simplifying and streamlining the process of updating and verifying the facility and professional reimbursement facts for a single documentation specialist, thereby further reducing the incidence of inconsistencies between finalized lists of facility and professional reimbursement facts.

As described in greater detail below, the methods of this disclosure may be performed by one or more computers. The methods may be performed by a stand alone computer, or may be executed in a client-server environment in which a documentation specialist views the patient encounter data at a client computer. In the later case, the client computer may communicate with a server computer. The server computer may store the patient encounter data and apply the techniques of this disclosure to facilitate review of the patient encounter data and updating and modification of the reimbursement facts by the documentation specialist at the client computer.

In one example, a method includes receiving, at one or more computers, patient encounter data describing a patient encounter with a healthcare organization. The method may further include determining, via the one or more computers, one or more facility reimbursement facts based on the patient encounter data and one or more professional reimbursement facts based on the patient encounter data. After determining one or more reimbursement facts, the method may output a user interface including a listing of the determined reimbursement facts. The method may further receive at the one or more or more computers, selection input associated with the facility reimbursement facts and the professional reimbursement facts. Finally, the method may receive, at the one or more computers, an indication that the facility reimbursement facts and the professional reimbursement facts are finalized.

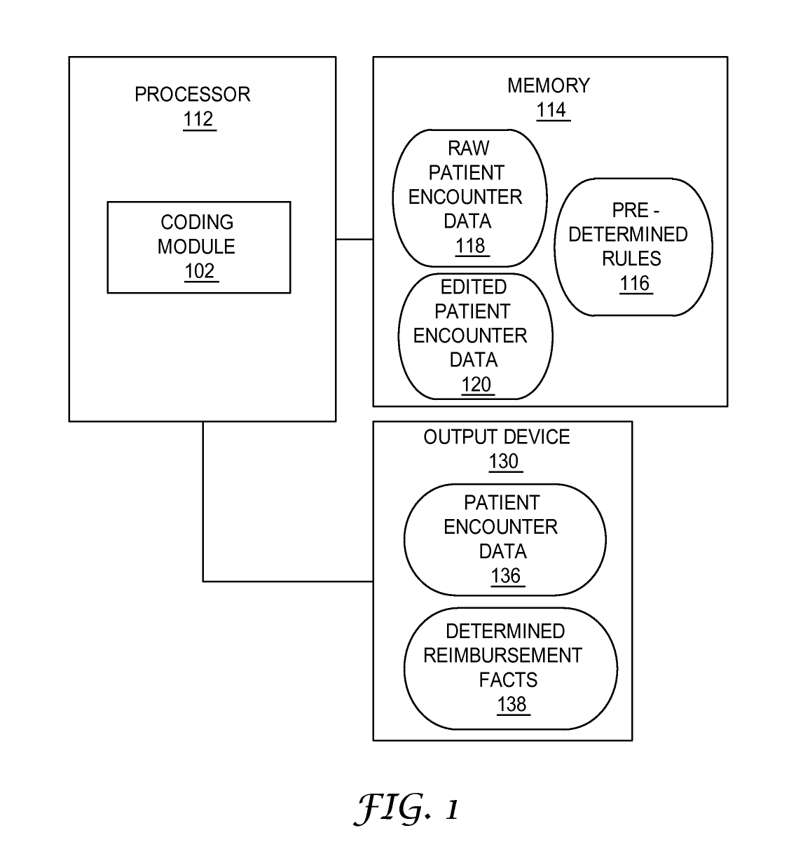

FIG. 1 is a block diagram illustrating an example of a stand-alone computerized system for coding medical data consistent with this disclosure. The system comprises computer 110 that includes a processor 112, a memory 114, and an output device 130. Computer 110 may also include many other components. The illustrated components are shown merely to explain various aspects of this disclosure.

Output device 130 may comprise a display screen, although this disclosure is not necessarily limited in this respect, and other types of output devices may also be used. Memory 114 stores raw patient encounter data 118, which may comprise data collected in documents such as patient medical records. Memory 114 may further store edited patient encounter data 120 and pre-determined rules 116. Processor 112 is configured to include a coding module 102 that executes techniques of this disclosure with respect to raw patient encounter data 118, and in some cases, coding module 102 may generate edited patient encounter data 120 comprising edited patient encounters.

Processor 112 may comprise a general-purpose microprocessor, a specially designed processor, an application specific integrated circuit, a field programmable gate array, a collection of discrete logic, or any type of processing device capable of executing the techniques described herein. In one example, memory 114 may store program instructions (e.g., software instructions) that are executed by processor 112 to carry out the techniques described herein. In other examples, the techniques may be executed by specifically programmed circuitry of processor 112. In these or other ways, processor 112 may be configured to execute the techniques described herein.

Output device 130 may comprise a display screen, and may also include other types of output capabilities. In some cases, output device 130 may generally represent both a display screen and a printer in some cases. Coding module 102 may be configured to cause output device 130 to output patient encounter data 136 and determined reimbursement facts 138. Patient encounter data 136 and determined reimbursement facts 138 may be generated, e.g., as output on a display screen, so as to allow a documentation specialist to add or modify the determined reimbursement facts 138. In this manner, edited patient encounter data 120 may be generated and stored based on raw patient encounter data 118 and based on additional information such as input from a documentation specialist. The techniques of this disclosure may serve to allow a single documentation specialist to verify and edit all reimbursement facts, including reimbursement facts associated with both facility reimbursement and professional reimbursement, in a single workflow.

In one example, coding module 102 receives raw patient encounter data 118. In some examples, coding module 102 may receive raw patient encounter data 118 in response to an indication to begin processing one or more patient medical records. Raw patient encounter data 118 may include information included in a patient medical record or any other documents or files describing a patient medical encounter with a healthcare facility. For example, when a patient has an encounter with a healthcare facility, such as during an inpatient admission or an outpatient visit, all of the information gathered during the encounter may be consolidated into a patient medical record. In one example, such a patient medical record may include any procedures performed, any medications prescribed (and given), any notes written by a physician or nurse, and generally any other information concerning the patient encounter with the medical facility. In some examples, the patient medical record may include one or more facility reimbursement facts, one or more professional reimbursement facts, or both.

The facility reimbursement facts and the professional reimbursement facts may be any information related to reimbursement for the services performed and equipment used during the patient medical encounter. These reimbursement facts may include, but are not limited to, medical billing codes. Examples of such medical billing codes include codes associated with the International Classification of Diseases (ICD) codes (versions 9 and 10), Current Procedural Technology (CPT) codes, a Healthcare Common Procedural Coding System codes (HCPCS), and Physician Quality Reporting System (PQRS) codes. In some examples, the codes associated with facility reimbursement include ICD codes, CPT codes, and HCPCS codes. Generally, these reimbursement facts are related to the services and equipment provided by the facility where the patient encounter occurred. Codes associated with professional reimbursement may include ICD codes, CPT codes, and PQRS codes. Generally, these reimbursement facts are related to the services and equipment provided by the attending medical professional. In other examples, the facility and professional reimbursement facts may include any medical billing codes.

As some examples, services provided by the facility may include nursing services or other services performed by employees of the facility. Examples of equipment may include various needles, IV tubing, diagnostic equipment, and other such medical equipment used during the patient encounter. Services provided by the attending medical professional (i.e. a medical doctor) may include diagnosis and treatment. Ultimately, these various reimbursement facts are supposed to describe the patient encounter including a diagnosis or reason for the encounter, a description of the services provided by both the facility and the medical professional, and a description of the equipment used by the facility to assist in diagnosis and treatment of the patient. By providing reimbursement facts to a payer (e.g. a governmental payer, or an insurance company, or any other person or entity paying for medical care), the facility and medical professionals are able to recoup costs and earn revenue based on the actual services provided and equipment used during the patient encounter.

Coding module 102 may further determine one or more facility or professional reimbursement facts included based on the raw patient encounter data 118. In at least one example, various medical professionals or healthcare facility employees may have already entered various reimbursement facts into a patient medical record during or shortly after the patient medical encounter. In such examples, coding module 102 may simply identify those previously entered reimbursement facts. In other examples, coding module 102 may determine the reimbursement facts based on natural language processing of the patient medical encounter. Generally, the natural language processing entails parsing information, such as that contained in a patient medical record, extracting keywords, and matching those keywords to one or more reimbursement facts. In still other examples, coding module 102 may determine reimbursement facts by both identifying previously entered reimbursement facts and by performing natural language processing on the patient medical record.

After determining one or more reimbursement facts based on raw patient encounter data 118, coding module 102 may further output a user interface. In at least one example, coding module 102 may first generate a user interface for output including a single window, and the window may include information based on raw patient encounter data 118. For example, the user interface window may include at least determined reimbursement facts 138. The determined reimbursement facts 138 may be the reimbursement facts previously determined by coding module 102, as described herein. Determined reimbursement facts 138 may further be broken into two categories: determined facility reimbursement facts and determined professional reimbursement facts. In some examples, the window may further include patient encounter data 136. Patient encounter data 136 may include other information stored in the patient medical record. For example, patient encounter data 136 may include descriptions of patient diagnosis, services provided, and equipment used during the patient medical encounter, among other information such as doctor's notes. Accordingly, in at least one example, coding module 102 may generate a window including the determined reimbursement facts 138, including both determined facility reimbursement facts and determined professional reimbursement facts, along with patient encounter data 136. According to these described techniques, a user, such as a documentation specialist, may view and modify all determined reimbursement facts 138 (including both facility and professional reimbursement facts) and other patient encounter data 136 in the same window. This consolidation of information may assist the documentation specialist in identifying inaccuracies and inconsistencies between the determined facility and professional reimbursement facts. In this manner, the techniques described herein may reduce the incidence of inaccuracies and inconsistencies in finalized determined reimbursement facts.

In other examples, the user interface may include multiple windows. Each window may include separate listings of determined reimbursement facts 138. For example, a first window may include determined reimbursement facts 138 associated with facility reimbursement and a second window may include determined reimbursement facts 138 associated with professional reimbursement. Further, one or more of the separate windows may also include patient encounter data 136. In at least one example, the two separate windows may include determined reimbursement facts 138 associated with only one of the reimbursement categories. A third window may then include determined reimbursement facts 138 common to both reimbursement categories. According to these described techniques, partitioning the various determined reimbursement facts into separate windows may also assist the user, such as a documentation specialist, in identifying inaccuracies and inconsistencies between the determined facility and professional reimbursement facts. Although in a multi-window system, the patient encounter data 136 and the various determined reimbursement facts 136 are more spread out than in a single-window system, the multi-window system may still offer various advantages. For example, in a multi-window system, a documentation specialist may maintain greater focus on the individual categories of reimbursement facts when comparing the facts to patient encounter data 136 for inaccuracies.

Regardless of whether the system includes a single- or multi-window user interface, coding module 102 may output the user interface to output device 130. As described above, output device 130 may be a display screen of one or more computers. Some example display screens include a monitor of a desktop computer or a laptop computer. In other examples, the display screen may be connected to a tablet computer or a mobile phone. In other examples, the display screen may not be associated with a single device, but may include the ability to connect to multiple computing devices. Further, output device 130 is not limited solely to display screens. For example, output device 130 may comprise a computer connected to computer 110, or any other known output device.

Coding module 102 may further receive selection input associated with the facility reimbursement facts and the professional reimbursement facts. The selection input may include data or commands input by a user. For example, the selection input may include additions to or deletions from either of the determined facility reimbursement facts, the determined professional reimbursement facts, or both within a patient medical record. The selection input also may include changes or edits to the existing determined facility or professional reimbursement facts. Accordingly, in at least one example, a user may view the output user interface including the determined reimbursement facts 138 (including both determined facility and professional reimbursement facts) and patient encounter data 136. The user may then review the output determined reimbursement facts 138 and patient encounter data 136 for accuracy. In some examples, the user may determine inaccuracies in determined reimbursement facts 138. The user may then enter additional reimbursement facts or delete one or more determined reimbursement facts 138. In other examples, a user may determine inconsistencies between the determined facility and the determined professional reimbursement facts. The user may then edit the determined reimbursement facts such as to conform the determined facility reimbursement facts to be consistent with the determined professional reimbursement facts. In still other examples, the user may determine both inaccuracies and inconsistencies in the determined facility and professional reimbursement facts. In such examples, the user may enter selection input including additions to, deletions from, and changes to determined reimbursement facts 138.

As described previously, coding module 102 may output a user interface including one or more windows. In the examples where coding module 102 outputs a single window including all of determined reimbursement facts 138 and patient encounter data 136, coding module 102 may receive selection input associated with any of determined reimbursement facts 138 at the single-window. For example, a user may review the output user interface and enter selection input associated with any of the determined facility reimbursement facts or any of the determined professional reimbursement facts. Again, the ability to review, and enter selection input associated with all the determined reimbursement facts 138 assists a user in ensuring accuracy and consistency between all the determined reimbursement facts 138 and patient encounter data 136.

In other examples, where coding module 102 outputs multiple windows, coding module 102 may receive selection input separately for the reimbursement facts associated with facility reimbursement and for the reimbursement facts associated with professional reimbursement. For example, if output device 130 outputs user interface including a first window where the window includes only determined facility reimbursement facts (possibly along with patient encounter data 136), the user may only enter selection input associated with the determined facility reimbursement facts. Accordingly, the user may enter selection input associated with determined professional reimbursement facts in the second output window, where the second window includes determined professional reimbursement facts (and possibly patient encounter data 136). The techniques described herein do not rely on any specific order of display of the described windows. Accordingly, the first window may include the determined professional reimbursement facts and the second window may include determined facility reimbursement facts. As described above, partitioning the displayed determined reimbursement facts 138 into separate windows may assist a user in ensuring accuracy between the determined reimbursement facts 138 and patient encounter data 136.

During the editing process, for example where a user enters selection input, coding module 102 may operate to store the additions/deletions and changes to determined reimbursement facts 138 within a patient medical record into memory. The edited patient medical record may be stored as edited patient encounter data 120.

Coding module 102 may further receive an indication that the determined facility reimbursement facts and the determined professional reimbursement facts are finalized. For instance, a user may review the output user interface including determined reimbursement facts 138 and patient encounter data 136. After reviewing the information for inaccuracies and inconsistencies, and after entering any necessary selection input, a user may input into computer 110 an indication that determined reimbursement facts 138 are finalized. Signalings coding module 102 that the determined reimbursement facts 138 are finalized may indicate that the determined reimbursement facts 138 are ready for subsequent billing-related processing. In some examples, determined reimbursement facts 138 may be further modified during the billing-related processing. In at least one example, the finalized determined reimbursement facts 138 may receive no further modification. In the described examples described where coding module 102 may output all determined reimbursement facts 138 in a single window, coding module 102 may receive a single indication that all determined reimbursement facts 138 are finalized. In the described examples where coding module 102 may output determined facility reimbursement facts and determined professional reimbursement facts, coding module 102 may receive separate indications that determined facility reimbursement facts and determined professional reimbursement facts are finalized.

After receiving an indication that determined reimbursement facts 138 are finalized, coding module 102 may further compare the finalized reimbursement facts to pre-determined rules 116. In some examples, pre-determined rules may be one or more rules identifying errors based on determined reimbursement facts 138. For example, one rule or set of rules may determine that when a particular determined reimbursement fact is present, a second determined reimbursement fact must be also present. As another example, another rule or set of rules may determine that when a particular determined reimbursement fact is present, a second determined reimbursement code may not be present. In such instances, coding module 102 may output to output device 130 a prompt indicating further action is necessary. Accordingly, a user may enter additional selection input in response to such prompts. This process may be repeated until no more pre-determined rules 116 trigger as coding module 102 compares determined reimbursement facts 138 to the pre-determined rules 116.

As described previously, coding module 102 may output a user interface including one or more windows. In the described examples where coding module 102 outputs a single window including all of determined reimbursement facts 138 and patient encounter data 136, coding module 102 may compare all the finalized reimbursement facts to the pre-determined rules 116 at the same time. In described examples including multiple windows, coding module 102 may compare the determined facility reimbursement facts and determined professional reimbursement facts at separate times. For example, coding module 102 may compare the determined facility reimbursement facts when coding module 102 receives an indication that the determined facility reimbursement facts are finalized. Accordingly, coding module 102 may compare the determined professional reimbursement facts when coding module 102 receives an indication that the determined professional reimbursement facts are finalized.

Further, coding module 102 may compare determined reimbursement facts 138 to the pre-determined rules 116 before receiving an indication that determined reimbursement facts 138 are finalized. For example, a user may input a separate command indicating that coding module 102 initiate the comparison between determined reimbursement facts 138 and the pre-determined rules 116. In these examples, when coding module 102 receives an indication that determined reimbursement facts 138 are finalized, coding module 102 may instead output a finalized listing of the determined reimbursement facts.

Once coding module 102 has received an indication that determined reimbursement facts 138 facts are finalized (and none of the pre-determined rules 116 triggers in the examples where receiving an indication that determined reimbursement facts 138 are finalized triggers a comparison), coding module 102 may further output a finalized listing of the determined reimbursement facts. For example, coding module 102 may output a first list containing only finalized determined reimbursement facts associated with facility reimbursement. Coding module 102 may further output a second list containing only finalized determined reimbursement facts associated with professional reimbursement. In another example, coding module 102 may output a single listing of reimbursement facts containing both finalized determined facility and finalized determined professional reimbursement facts. Coding module 102 may also output the one or more lists of finalized determined reimbursement facts to one or more different locations. For example, coding module 102 may output the finalized determined reimbursement facts in a user interface to output device 130. In other examples, coding module 102 may output the finalized determined reimbursement facts to a billing department for further modification before being sent to one or more payers to provide reimbursement based on the finalized determined reimbursement facts.

In some examples, coding module 102 may further generate a value of facility and professional reimbursement based on the finalized determined reimbursement facts. For example, each reimbursement fact may be associated with a reimbursement value or may modify reimbursement values of other reimbursement facts. In such examples, coding module 102 may separate the finalized determined facility reimbursement facts from the finalized determined professional reimbursement facts. In this manner, coding module 102 may calculate the value of a reimbursement to the facility based on the finalized determined facility reimbursement facts. Coding module 102 may further calculate the value of a reimbursement to a medical professional based on the finalized determined professional reimbursement facts.

The system of FIG. 1 is a stand-alone system in which processor 112 that executed coding module 102 and output device 130 that outputs determined reimbursement facts 138 patient encounter data 136 reside on the same computer 110. However, the techniques of this disclosure may also be performed in a distributed system that includes a server computer and a client computer. In this case, the client computer may communicate with the server computer via a network. The coding module may reside on the server computer, but the output device may reside on the client computer. In this case, when the coding module causes display prompts, the coding module causes the output device of the client computer to display the prompts, e.g., via commands or instructions communicated based on the server computer to the client computer.

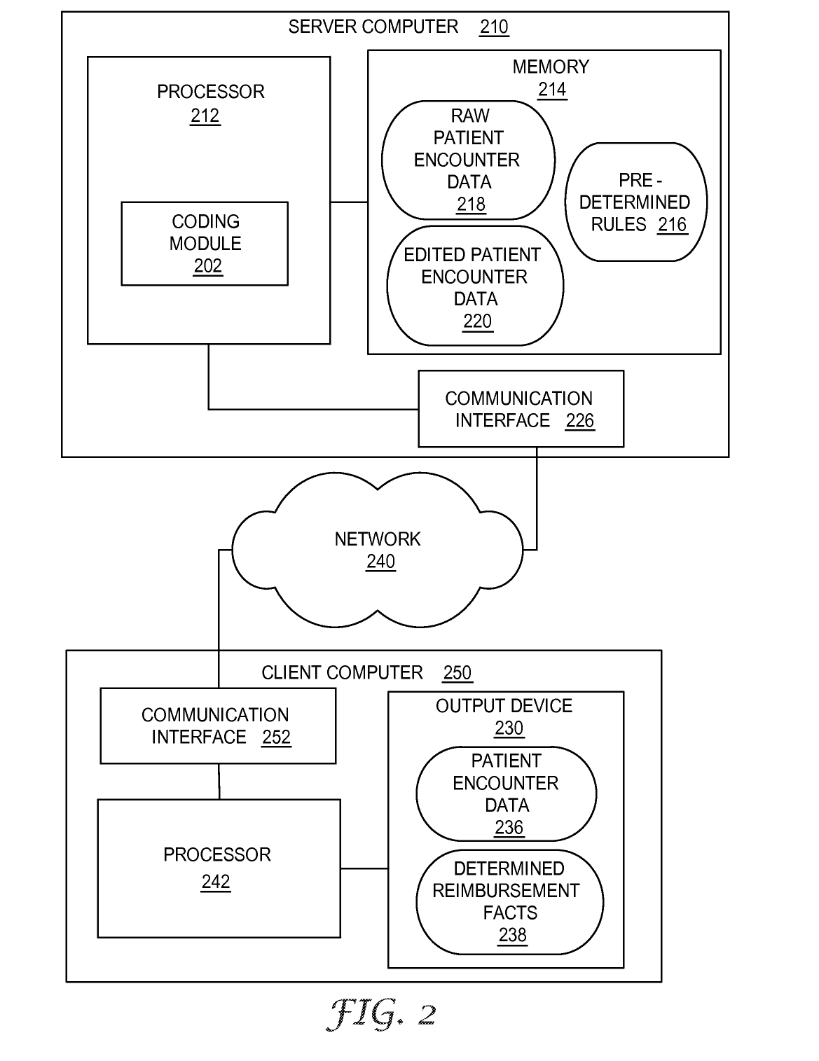

FIG. 2 is a block diagram of a distributed system that includes a server computer 210 and a client computer 250 that communicate via a network 240. In the example of FIG. 2, network 240 may comprise a proprietary on non-proprietary network for packet-based communication. In one example, network 240 comprises the Internet, in which case communication interfaces 226 and 252 may comprise interfaces for communicating data according to transmission control protocol/internet protocol (TCP/IP), user datagram protocol (UDP), or the like. More generally, however, network 240 may comprise any type of communication network, and may support wired communication, wireless communication, fiber optic communication, satellite communication, or any type of techniques for transferring data between a source (e.g., server computer 210) and a destination (e.g., client computer 240).

Server computer 210 may perform the techniques of this disclosure, but the documentation specialist (i.e., the user) may interact with the system via client computer 250. Server computer 210 may include a processor 212, a memory 214, and a communication interface 226. Client computer 250 may include a communication interface 252, a processor 242 and an output device 230. Of course, client computer 250 and server computer 210 may include many other components. The illustrated components are shown merely to explain various aspects of this disclosure.

Output device 230 may comprise a display screen, although this disclosure is not necessarily limited in this respect and other output devices may also be used. Memory 214 stores raw patient encounter data 218, which may comprise data collected in documents such as patient medical records. Processor 212 of server computer 210 is configured to include a coding module 202 that executes techniques of this disclosure with respect to raw patient encounter data 218, and in some cases, coding module 202 may generate edited patient encounter data 220 comprising edited patient encounters.

Processors 212 and 242 may each comprise a general-purpose microprocessor, a specially designed processor, an application specific integrated circuit, a field programmable gate array, a collection of discrete logic, or any type of processing device capable of executing the techniques described herein. In one example, memory 214 may store program instructions (e.g., software instructions) that are executed by processor 212 to carry out the techniques described herein. In other examples, the techniques may be executed by specifically programmed circuitry of processor 212. In these or other ways, processor 212 may be configured to execute the techniques described herein.

Output device 230 on client computer 250 may comprise a display screen, and may also include other types of output capabilities. For example, output device 230 may generally represent both a display screen and a printer in some cases. Coding module 202 may be configured to cause output device 230 of client computer 250 to output patient encounter data 236 and determined reimbursement facts 238. Patient encounter data 236 and determined reimbursement facts 238 may be generated, e.g., as output on a display screen, so as to allow a documentation specialist to add or modify the determined reimbursement facts 238. In this manner, edited patient encounter data 220 may be generated and stored based on raw patient encounter data 218 and based on additional information such as input from a documentation specialist. Again, the techniques of this disclosure may serve to allow a single documentation specialist to verify and edit all reimbursement facts, including reimbursement facts associated with both facility reimbursement and professional reimbursement, in a single workflow.

Similar to the stand alone example of FIG. 1, in the distributed example of FIG. 2, coding module 202 receives raw patient encounter data 218 in response to an indication to begin processing one or more patient medical records. Coding module 202 may receive such an indication to begin processing from client computer 250. Again, communication interfaces 226 and 252 allow for communication between server computer 210 and client computer 250 via network 240. In this way, coding module 202 may execute on server computer 210 but may receive input from client computer 250. A documentation specialist operating on client computer 250 may log-on or otherwise access coding module 202 of server computer 210, such as via a web-interface operating on the Internet or a propriety network, or via a direct or dial-up connection between client computer 250 and server computer 210. In some cases, data displayed on output device 230 (including any determined reimbursement facts 238 facts or patient encounter data 236) may be arranged in web pages served from server computer 210 to client computer 250 via hypertext transfer protocol (HTTP), extended markup language (XML), or the like.

Raw patient encounter data 218 may include information included in a patient medical record or other documents or files describing a patient medical encounter with a healthcare facility. Again, when a patient has an encounter with a healthcare facility, such as during an inpatient admission or an outpatient visit, all of the information gathered during the encounter may be consolidated into a patient medical record. Accordingly, a patient medical record may include information about any procedures performed, any medications prescribed (and given), any notes written by a physician or nurse, and generally any other information concerning the patient encounter with the medical facility. In some examples, the patient medical record may include one or more facility reimbursement facts, one or more professional reimbursement facts, or both. These reimbursement facts may be similar to the reimbursement fact previously described herein. For example, these reimbursement facts may include, but are not limited to, medical billing codes. Examples of such medical billing codes include codes associated with the International Classification of Diseases (ICD) codes (versions 9 and 10), Current Procedural Technology (CPT) codes, a Healthcare Common Procedural Coding System codes (HCPCS), and Physician Quality Reporting System (PQRS) codes. In some examples, the codes associated with facility reimbursement include ICD codes, CPT codes, and HCPCS codes.

Coding module 202 may further determine one or more facility or professional reimbursement facts included based on the raw patient encounter data 218. In at least one example, various medical professionals or healthcare facility employees may have already entered various reimbursement facts into a patient medical record during or shortly after the patient medical encounter. In such examples, coding module 202 may simply identify those previously entered reimbursement facts. In other examples, coding module 202 may determine the reimbursement facts based on natural language processing of the patient medical encounter. Generally, natural language processing entails parsing information, such as that contained in a patient medical record, extracting keywords, and matching those keywords to one or more reimbursement facts. In at least one example, coding module 202 may employ the methods of natural language processing previously described herein. In still other examples, coding module 202 may determine reimbursement facts by both identifying previously entered reimbursement facts and by performing natural language processing on the patient medical record.

After determining one or more reimbursement facts based on raw patient encounter data 218, coding module 202 may further output a user interface including patient encounter data 236. In at least one example, coding module 202 may first generate a user interface for output including a single window, and the window may include information based on raw patient encounter data 218. For example, the user interface window may include at least determined reimbursement facts 238. The determined reimbursement facts 238 may be the reimbursement facts previously determined by coding module 202, as described herein. Determined reimbursement facts 238 may further be broken into two categories: determined facility reimbursement facts and determined professional reimbursement facts. In some examples, the window may further include patient encounter data 236. Patient encounter data 236 may also include other information stored in the patient medical record. For example, patient encounter data 236 may include descriptions of patient diagnosis, services provided, and equipment used during the patient medical encounter, among other information such as doctor's notes. Accordingly, in at least one example, coding module 202 may generate a window including determined reimbursement facts 238 (including both determined facility reimbursement facts and determined professional reimbursement facts) along with patient encounter data 236 in a single window. As described previously, this consolidation of information may assist a user, such as a documentation specialist, in verifying and modifying the determined reimbursement facts 238 associated with a patient medical record so as to be consistent and accurate for submission to one or more payers.

In other examples, the user interface may include multiple windows. Each window may include separate listings of determined reimbursement facts 238. For example, a first window may include determined reimbursement facts 238 associated with facility reimbursement and a second window may include determined reimbursement facts 238 associated with professional reimbursement. Further, one or more of the separate windows may also include patient encounter data 236. In at least one example, the two separate windows may include determined reimbursement facts 238 associated with only one of the reimbursement categories. A third window may then include determined reimbursement facts 238 common to both reimbursement categories. Also as described previously, this separation of determined reimbursement facts 238 may assist a user, such as a documentation specialist, in verifying and modifying the determined reimbursement facts 238 so as to be consistent and accurate for submission to one or more payers.

Coding module 202 may output the user interface to output device 130. As described previously, output device 230 may be a display screen of one or more computers, or any other device capable of displaying a user interface. As described above, communication interfaces 226 and 252 allow for communication between server computer 210 and client computer 250 via network 240. In this way, coding module 202 may execute on server computer 210 but the output may appear on output device 230 of client computer 250.

Coding module 202 may further receive at a computer, such as at client computer 250, selection input associated with the facility reimbursement facts and the professional reimbursement facts. The selection input may include data or commands input by a user. For example, the selection input may include additions to or deletions from either of the determined facility reimbursement facts, the determined professional reimbursement facts, or both within a patient medical record. The selection input also may include changes or edits to the existing determined facility or professional reimbursement facts. Accordingly, in at least one example, a user may view the output user interface including the determined reimbursement facts 238 (including both determined facility and professional reimbursement facts) and patient encounter data 236. The user may then review the output determined reimbursement facts 238 and patient encounter data 236 for accuracy and consistency. In some examples, the user may determine inaccuracies in determined reimbursement facts 238. The user may then enter additional reimbursement facts or delete one or more determined reimbursement facts 238 at a computer, such as client computer 250. In other examples, a user may determine inconsistencies between the determined facility and the determined professional reimbursement facts. The user may then edit the determined reimbursement facts such as to conform the determined facility reimbursement facts to be consistent with the determined professional reimbursement facts. In still other examples, the user may determine both inaccuracies and inconsistencies in the determined facility and professional reimbursement facts. In such examples, the user may enter selection input including additions to, deletions from, and changes to determined reimbursement facts 238.

As described previously, coding module 202 may output a user interface including one or more windows. In the examples where coding module 202 outputs a single window including all of determined reimbursement facts 238 and patient encounter data 236, coding module 202 may receive selection input associated with any of determined reimbursement facts 238 at the single user interface window. For example, a user may review the output user interface and enter selection input associated with any of the determined facility reimbursement facts or any of the determined professional reimbursement facts. In this manner, the described technique may assist a user in ensuring accuracy and consistency between determined reimbursement facts 138 and patient encounter data 136.

In other examples where coding module 202 outputs multiple windows, coding module 202 may receive selection input separately for reimbursement facts associated with facility reimbursement and for reimbursement facts associated with professional reimbursement. For example, if output device 230 outputs user interface including a first window where the window includes only determined facility reimbursement facts (possibly along with patient encounter data 236), the user may only enter selection input associated with the determined facility reimbursement facts. Accordingly, the user may enter selection input associated with determined professional reimbursement facts in the second output window, where the second window includes determined professional reimbursement facts (and possibly patient encounter data 236). The techniques described herein do not rely on any specific display order of the windows. For example, the first window may include the determined professional reimbursement facts and the second window may include determined facility reimbursement facts. Further, as described previously, separating the determined reimbursement facts 238 into separate display windows may assist a user in ensuring accuracy and consistency between determined reimbursement facts 238 and patient encounter data 236.

During the editing process, for example where a user enters selection input, coding module 202 may operate to store the additions/deletions and changes to determined reimbursement facts 238 within a patient medical record into memory. The edited patient medical record may be stored as edited patient encounter data 220.

Coding module 202 may further receive an indication that the determined facility reimbursement facts and the determined professional reimbursement facts are finalized. For instance, a user may review the output user interface including determined reimbursement facts 238 and patient encounter data 236. After reviewing the information for inaccuracies and inconsistencies, and after entering any necessary selection input, a user may input at a computer, such as client computer 250, an indication that determined reimbursement facts 238 are finalized. Signaling coding module 202 that the determined reimbursement facts 138 are finalized may indicate that the determined reimbursement facts 138 are ready for subsequent billing-related processing. In some examples, determined reimbursement facts 138 may be further modified during the billing-related processing. In at least one example, the finalized determined reimbursement facts 138 may receive no further modification. In the described examples described where coding module 202 may output all determined reimbursement facts 238 in a single window, coding module 202 may receive a single indication that all determined reimbursement facts 238 are finalized. In the described examples where coding module 202 may output determined facility reimbursement facts and determined professional reimbursement facts, coding module 202 may receive separate indications that determined facility reimbursement facts and determined professional reimbursement facts are finalized.

After receiving an indication that determined reimbursement facts 238 are finalized, coding module 202 may further compare the finalized reimbursement facts to pre-determined rules 216. In such examples, coding module 202 may output to output device 230 a prompt indicating further action is necessary. Accordingly, a user may enter additional selection input in response to such prompts. This process may be repeated until no more pre-determined rules 216 trigger as coding module 202 compares determined reimbursement facts 238 to the pre-determined rules 216. The examples of predetermined rules described above in relation to FIG. 1 are applicable to this description as well.

As described previously, coding module 202 may output a user interface including one or more windows. In the described examples where coding module 202 outputs a single window including all of determined reimbursement facts 238 and patient encounter data 236, coding module 202 may compare all the finalized reimbursement facts to the pre-determined rules 216 at the same time. In described examples including multiple windows, coding module 202 may compare the determined facility reimbursement facts and determined professional reimbursement facts as separate times. For example, coding module 202 may compare the determined facility reimbursement facts when coding module 202 receives an indication that the determined facility reimbursement facts are finalized. Accordingly, coding module 202 may compare the determined professional reimbursement facts when coding module 202 receives an indication that the determined professional reimbursement facts are finalized.

Further, coding module 202 may compare determined reimbursement facts 238 to the pre-determined rules 216 before receiving an indication that determined reimbursement facts 238 are finalized. For example, a user may input a separate command indicating that coding module 202 initiate the comparison between determined reimbursement facts 238 and the pre-determined rules 216. In these examples, when coding module 202 receives an indication that determined reimbursement facts 238 are finalized, coding module 202 may instead output a finalized listing of the determined reimbursement facts.

Once coding module 202 has received an indication that determined reimbursement facts 238 facts are finalized (and none of the pre-determined rules 216 triggers in the examples where receiving an indication that determined reimbursement facts 238 are finalized triggers a comparison), coding module 202 may further output a finalized listing of the determined reimbursement facts. For example, coding module 202 may output a first list containing only finalized determined reimbursement facts associated with facility reimbursement. Coding module 202 may further output a second list containing only finalized determined reimbursement facts associated with professional reimbursement. In another example, coding module 202 may output a single listing of reimbursement facts containing both finalized determined facility and finalized determined professional reimbursement facts. Coding module 202 may also output the one or more lists of finalized determined reimbursement facts to one or more different locations. For example, coding module 202 may output the finalized determined reimbursement facts in a user interface to output device 230. In other examples, coding module 202 may output the finalized determined reimbursement facts to a billing department for further modification before being sent to one or more payers to provide reimbursement based on the finalized determined reimbursement facts.

In some examples, coding module 202 may further generate a value of facility and professional reimbursement based on the finalized determined reimbursement facts. For example, each reimbursement fact may be associated with a reimbursement value or may modify reimbursement values of other reimbursement facts. In such examples, coding module 202 may separate the finalized determined facility reimbursement facts from the finalized determined professional reimbursement facts. In this manner, coding module 202 may calculate the value of a reimbursement to the facility based on the finalized determined facility reimbursement facts. Coding module 202 may further calculate the value of a reimbursement to a medical professional based on the finalized determined professional reimbursement facts. Coding module 202 may output these determined reimbursement values to output device 230, or to other devices or programs connected to server computer 210.

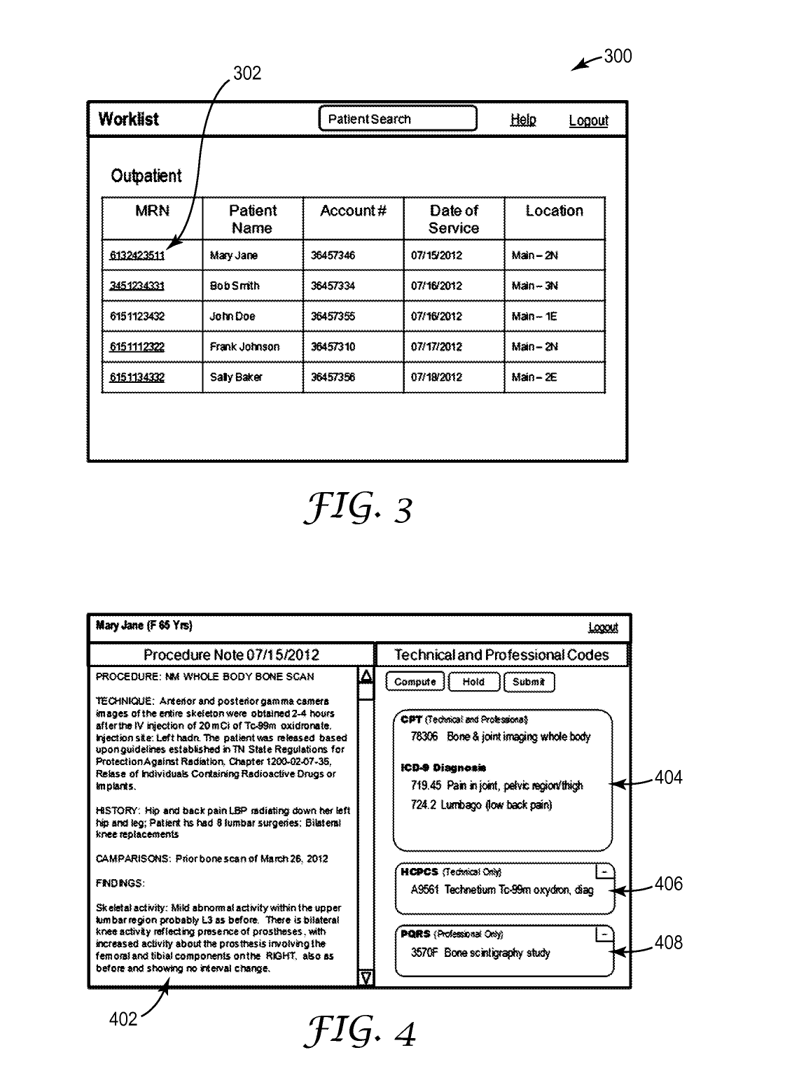

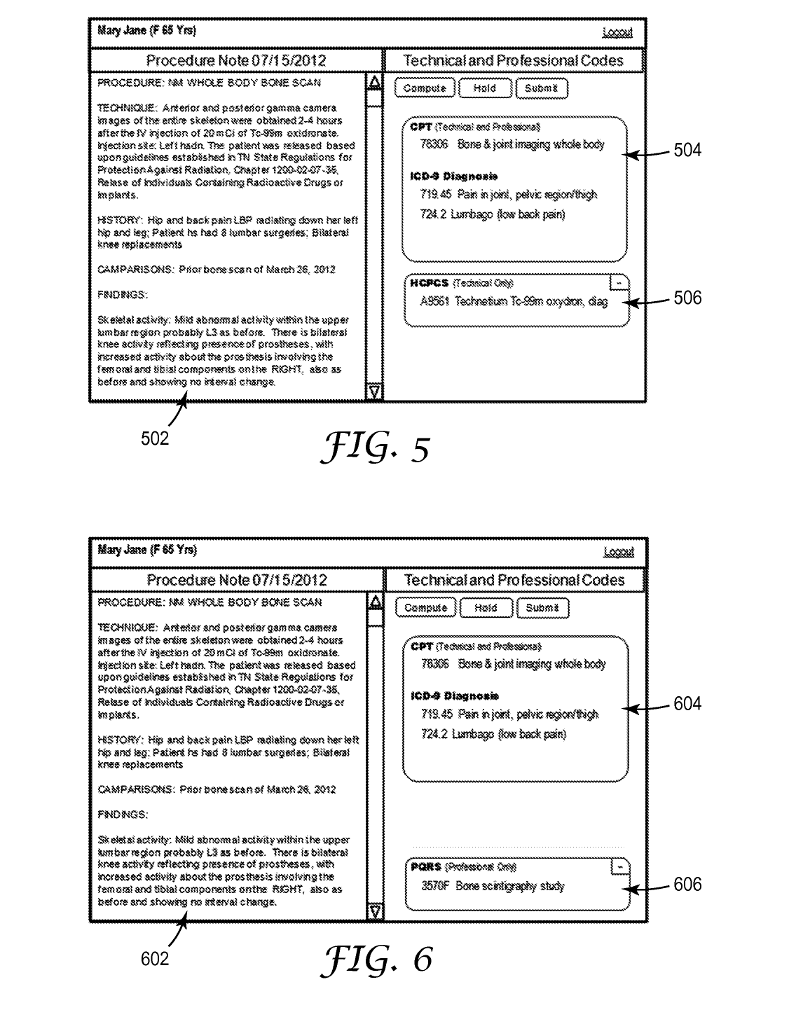

FIGS. 3-4 are example diagrams and FIGS. 5-6 are computer screenshots may be representative of a user interface according to aspects of this disclosure. For example, the diagrams or screenshots may be output at output device 130 of computer 110 shown in FIG. 1 or output device 230 of client computer 250 as shown in FIG. 2. In each case the diagrams or screenshots may be generating as part of the coding process (i.e. coding module 102 or 202) executed by processor 112 of computer 110 shown in FIG. 1, or executed by processor 212 of client computer 250 shown in FIG. 2.

A documentation specialist may select a patient record in order to review the documentation that a medical professional or a healthcare facility employee created in response to a patient medical encounter. FIG. 3 illustrates an example diagram 300 a documentation specialist may encounter during the coding process. The diagram illustrates a list of patient medical records. Each patient medical record may be identified by a unique number 302. The documentation specialist may select one or more patient medical records to begin the coding process described herein.

After selecting one or more patient medical records to code, the documentation specialist may be presented with a single patient medical record. FIG. 4 is an example diagram which illustrates a patient medical record a documentation specialist may encounter during the coding process. FIG. 4 illustrates that the patient medical record may display patient encounter data 402, such as patient encounter data 136 or patient encounter data 236 as described in FIGS. 1-2, along with both determined facility reimbursement facts and determined professional reimbursement facts. In the specific example described in FIG. 4, the diagram illustrates the determined reimbursement facts separated into three separate groupings. Reimbursement facts 404 represent a listing of reimbursement facts common to both facility reimbursement and professional reimbursement fact groups. Reimbursement facts 406 represent a listing of reimbursement facts associated with only facility reimbursement. Reimbursement facts 408 represent a listing of reimbursement facts associated with only professional reimbursement. Other examples may break the determined reimbursement facts into fewer categories, such as reimbursement facts associated with facility reimbursement and reimbursement facts associated with professional reimbursement. As described herein, including all the determined reimbursement facts and patient encounter data in a single window may assist a user in ensuring accuracy and consistency between all of the data for later submission to a payer.

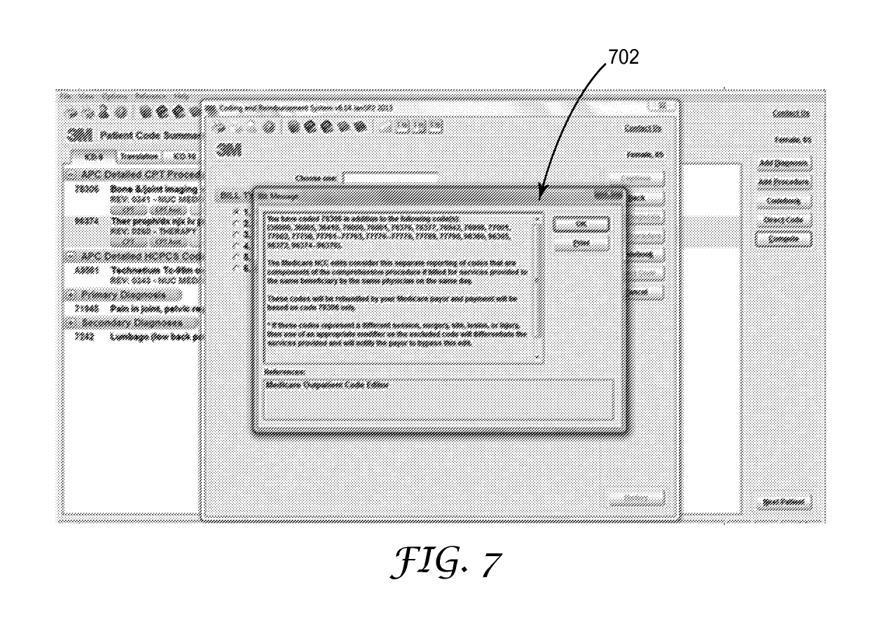

FIGS. 5-6 illustrate another example where the determined facility reimbursement facts and the determined professional reimbursement facts in separate windows along with the patient encounter data. For example, FIG. 5 illustrates a first window including patient encounter data 502, determined reimbursement facts 504 common to both facility and professional reimbursement, and determined facility reimbursement facts 506. FIG. 6 illustrates a second window including patient encounter data 602, determined reimbursement facts 604 common to both facility and professional reimbursement, and determined professional reimbursement facts 606. FIGS. 5-6 are meant only to illustrate one example where the determined reimbursement facts are split into separate windows. The techniques described herein contemplate other arrangements of the various date split into multiple windows. Again, as described previously, splitting the information into separate windows may provide one or more advantages in assisting a user to ensure accuracy and consistency between the determined reimbursement facts and the patient encounter data for submission to a payer. FIG. 7 illustrates an example screenshot displaying selection input. As described previously, in some instances, a user reviewing a patient medical record in order to verify or update reimbursement facts may determine inaccuracies or inconsistencies between the determined facility reimbursement facts and the determined professional reimbursement facts. In such examples, a user may enter selection input to add or delete or otherwise modify the displayed determined reimbursement facts. In the example of FIG. 7, a user may access window 702 and enter in any selection input to modify the determined reimbursement facts associated with the current patient medical record.

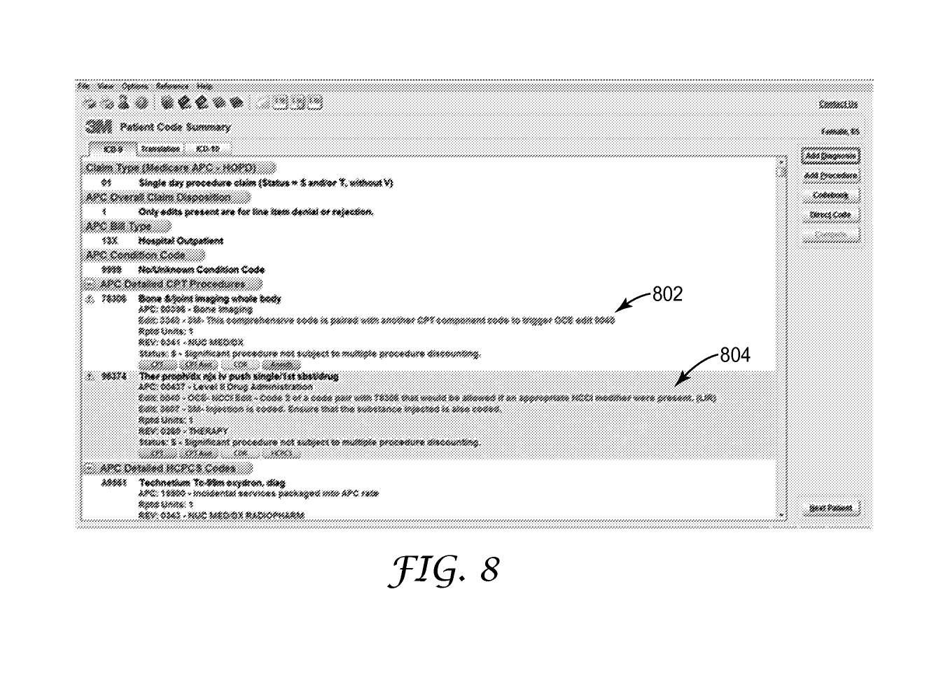

FIG. 8 is an example of a screenshot displaying prompts indicating changes need to be made to one or more determined reimbursement facts. As described previously, after finalizing the determined reimbursement facts, a user may encounter prompts based on one or more predetermined rules, such as predetermined rules 116 or predetermined rules 216 as described in FIGS. 1-2, indicating that more edits need to be made to the determined reimbursement facts in the current patient medical record. For example, prompt 802 indicates that an existing reimbursement fact requires the presence of another reimbursement fact. Accordingly, the user should enter selection input adding the associated reimbursement fact. The prompts indicated by prompt 804 indicate further edits that a user should make before finalizing the determined reimbursement facts.

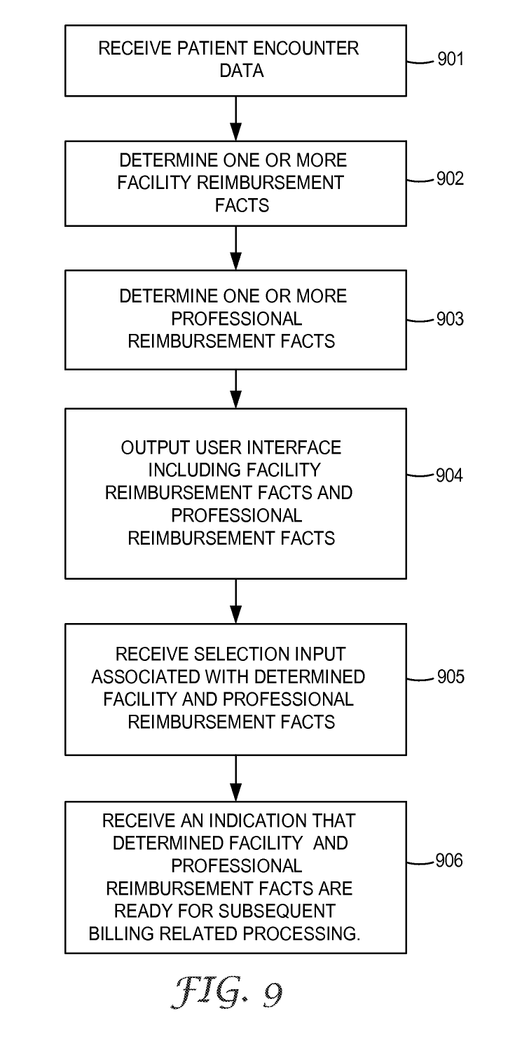

FIG. 9 is a flow diagram illustrating a technique consistent with this disclosure. FIG. 9 will be described from the perspective of computer 110 of FIG. 1, although the system of FIG. 2 or other systems could also be used to perform such techniques. As shown in FIG. 9, coding module 102 receives raw patient encounter data 118 (901). Raw patient encounter data 118 may include information included in a patient medical record or other document describing a patient medical encounter with a healthcare facility. The raw patient encounter data 118 may include one of many medical records within raw medical data 118 needing review by a documentation specialist.

Coding module 102 also determines one or more facility reimbursement facts based on the raw patient encounter data 118 (902). Coding module 102 may determine the one or more facility reimbursement facts by identifying facility reimbursement facts previously entered into the patient medical record and stored as raw patient encounter data 118. Coding module 102 may further identify facility reimbursement facts based on natural language processing of the raw patient encounter data 118.

Coding module 102 further determines one or more professional reimbursement facts based on the raw patient encounter data 118 (903). Similarly to determining one or more facility reimbursement facts, coding module may determine one or more professional reimbursement facts by identifying professional reimbursement facts previously entered into the patient medical record and stored as raw patient encounter data 118, by employing a natural language processing method on the raw patient encounter data 118, or some combination of the two.

Coding module 102 also outputs a user interface including facility reimbursement facts and professional reimbursement facts (904). As noted above, the user interface may include one or more windows. Further, the one or more windows may be structured to display a variety of information. For example, a single window may include determined reimbursement facts 138 along with patient encounter data 136. In some examples, the determined reimbursement facts 138 may be split into different sections in the window indicating determined reimbursement facts associated with facility reimbursement, determined reimbursement facts associated with professional reimbursement, or determined reimbursement facts associated with both facility and professional reimbursement. In other examples, the information may be split up into separate windows.

Further, coding module 102 may output the user interface, including the one or more windows, to output device 130. As described above, output device 130 may be a display screen of one or more computers. Some example display screens include a monitor of a desktop computer or a laptop computer. In other examples, the display screen may be connected to a tablet computer or a mobile phone. In other examples, the display screen may not be associated with a single device, but may include the ability to connect to multiple computing devices. Further, output device 130 is not limited solely to display screens. For example, output device 130 may comprise a computer connected to computer 110, or any other known output device.

Coding module 102 may receive selection input associated with the determined facility and professional reimbursement facts (905). As described previously, a user may determine inaccuracies or inconsistencies with one or more of the determined reimbursement facts 138. Accordingly, the user may enter selection input adding/deleting or changing one or more of the determined reimbursement facts 138. Based on the structure of the output user interface, coding module may receive selection input associated with all determined reimbursement facts in a single window. In other examples, coding module 102 may receive selection input associated with determined facility reimbursement facts and determined professional reimbursement facts in separate windows.

Coding module also receives an indication that the determined facility and professional reimbursement facts are finalized (906). As described previously, a user may review the output user interface including determined reimbursement facts 138 and patient encounter data 136. After reviewing the information for inaccuracies and inconsistencies, and after entering any necessary selection input, a user may input computer 110 an indication that determined reimbursement facts 138 are finalized. This input signals coding module 102 that no more changes to determined reimbursement facts 138 are necessary.

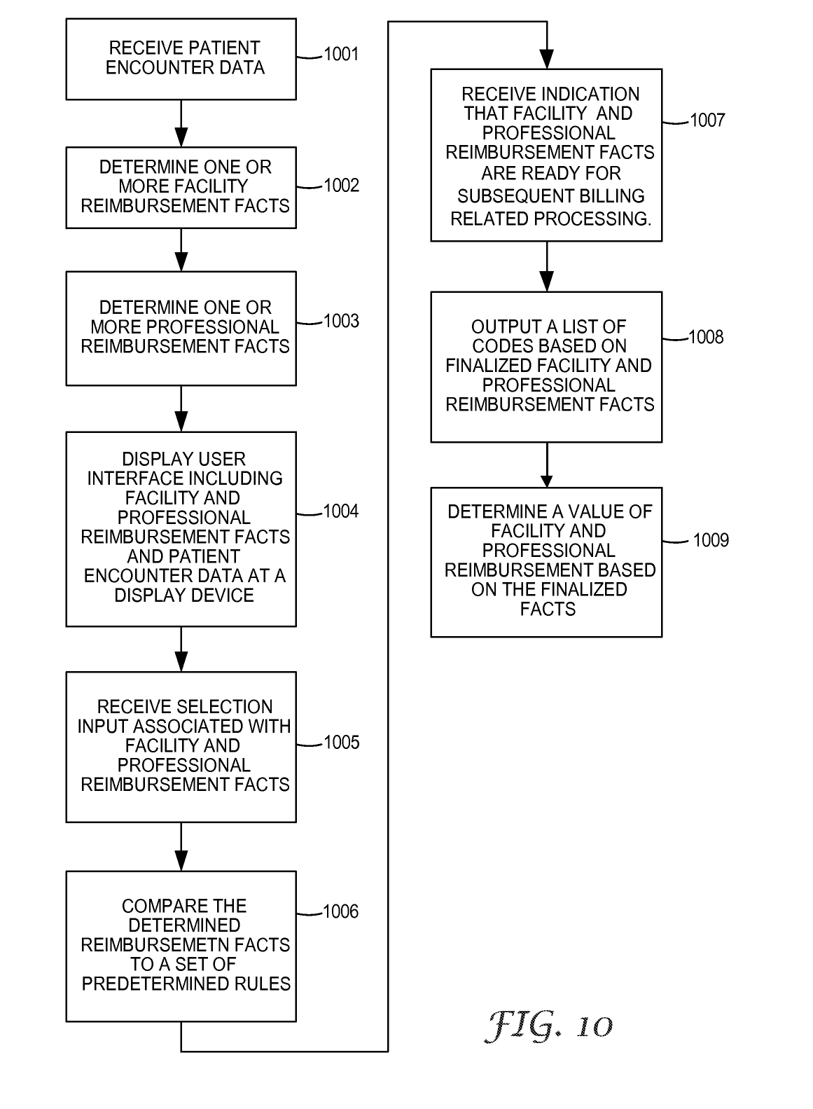

FIG. 10 is a flow diagram illustrating a more detailed technique consistent with this disclosure. FIG. 10 will be described from the perspective of computer 110 of FIG. 1, although the system of FIG. 2 or other systems could also be used to perform such techniques. As shown in FIG. 10, coding module 102 receives raw patient encounter data 118 (1001). Raw patient encounter data 118 may include information included in a patient medical record or other document describing a patient medical encounter with a healthcare facility. The raw patient encounter data 118 may include one of many medical records within raw medical data 118 needing review by a documentation specialist.

Coding module 102 also determines one or more facility reimbursement facts based on the raw patient encounter data 118 (1002). Coding module 102 may determine the one or more facility reimbursement facts by identifying facility reimbursement facts previously entered into the patient medical record and stored as raw patient encounter data 118. Coding module 102 may further identify facility reimbursement facts based on natural language processing of the raw patient encounter data 118.

Coding module 102 further determines one or more professional reimbursement facts based on the raw patient encounter data 118 (1003). Similarly to determining one or more facility reimbursement facts, coding module may determine one or more professional reimbursement facts by identifying professional reimbursement facts previously entered into the patient medical record and stored as raw patient encounter data 118, by employing a natural language processing method on the raw patient encounter data 118, or some combination of the two.

Coding module 102 also outputs a user interface including facility reimbursement facts and professional reimbursement facts (1004). As noted above, the user interface may include one or more windows. Further, the one or more windows may be structured to display a variety of information. For example, a single window may include determined reimbursement facts 138 along with patient encounter data 136. In some examples, the determined reimbursement facts 138 may be split into different sections in the window indicating determined reimbursement facts associated with facility reimbursement, determined reimbursement facts associated with professional reimbursement, or determined reimbursement facts associated with both facility and professional reimbursement. In other examples, the information may be split up into separate windows.

Further, coding module 102 outputs the user interface, including the one or more windows, to output device 130. As described above, output device 130 may be a display screen of one or more computers. Some example display screens include a monitor of a desktop computer or a laptop computer. In other examples, the display screen may be connected to a tablet computer or a mobile phone. In other examples, the display screen may not be associated with a single device, but may include the ability to connect to multiple computing devices. Further, output device 130 is not limited solely to display screens. For example, output device 130 may comprise a computer connected to computer 110, or any other known output device.

Coding module 102 further receives selection input associated with the determined facility and professional reimbursement facts (1005). As described previously, a user may determine inaccuracies or inconsistencies with one or more of the determined reimbursement facts 138. Accordingly, the user may enter selection input adding/deleting or changing one or more of the determined reimbursement facts 138. Based on the structure of the output user interface, coding module may receive selection input associated with all determined reimbursement facts in a single window. In other examples, coding module 102 may receive selection input associated with determined facility reimbursement facts and determined professional reimbursement facts in separate windows.

Coding module 102 also compares determined reimbursement facts 138 to predetermined rules 116. The rules may specify conditions where when a particular reimbursement fact is present in a patient medical record, one or more corresponding reimbursement facts must also be present. Other rules may further describe relationships where if a particular reimbursement codes is present in a patient medical record, a one or more additional reimbursement facts may not be present. Other such predetermined rules were described in more detail with regards to FIG. 1.

Coding module 102 also receives an indication that the determined facility and professional reimbursement facts are finalized (1007). As described previously, a user may review the output user interface including determined reimbursement facts 138 and patient encounter data 136. After reviewing the information for inaccuracies and inconsistencies, and after entering any necessary selection input, a user may input computer 110 an indication that determined reimbursement facts 138 are finalized. This input signals coding module 102 that no more changes to determined reimbursement facts 138 are necessary.

Coding module 102 further outputs a listing of finalized determined facility and professional reimbursement facts (1008). As described previously, the finalized listing may comprise two separate listing of determine reimbursement facts 138. For example, coding module 102 may output a first list containing only finalized determined reimbursement facts associated with facility reimbursement. Coding module 102 may further output a second list containing only finalized determined reimbursement facts associated with professional reimbursement. In another example, coding module 102 may output a single listing of reimbursement facts containing both finalized determined facility and finalized determined professional reimbursement facts.

Coding module 102 further determines a value of facility and professional reimbursement based on the finalized determined reimbursement facts (1009). In some examples, coding module 102 may determine a value of facility and professional reimbursement based on the finalized determined reimbursement facts. For example, each reimbursement fact may be associated with a reimbursement value or may modify reimbursement values of other reimbursement facts. In such examples, coding module 102 may separate the finalized determined facility reimbursement facts from the finalized determined professional reimbursement facts. In this manner, coding module 102 may determine the value of a reimbursement to the facility based on the finalized determined facility reimbursement facts. Coding module 102 may further determine the value of a reimbursement to a medical professional based on the finalized determined professional reimbursement facts.

The techniques of this disclosure may be implemented in a wide variety of computer devices, such as servers, laptop computers, desktop computers, notebook computers, tablet computers, hand-held computers, smart phones, and the like. Any components, modules or units have been described provided to emphasize functional aspects and does not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

These and other examples are within the scope of the following claims.

What is claimed:

1. A method of processing medical data via one or more computers, the method comprising:
receiving, at the one or more computers, patient encounter data describing a patient encounter with a healthcare organization;
determining, via the one or more computers, one or more facility reimbursement facts based on the patient encounter data;
determining, via one or more computers, one or more professional reimbursement facts based on the patient encounter data;
outputting a user interface including a listing of the determined facility reimbursement facts and a listing of the determined professional reimbursement facts;
receiving, at the one or more or more computers, selection input associated with the facility reimbursement facts and the professional reimbursement facts; and
receiving, at the one or more computers, an indication that the facility reimbursement facts and the professional reimbursement facts are ready for subsequent billing-related processing.

2. The method of claim 1, further comprising displaying the user interface at a display device.

3. The method of claim 1, further comprising outputting the patient encounter data in the user interface.

4. The method of claim 1, wherein receiving selection input comprises receiving selection input associated with the facility reimbursement facts and the professional reimbursement facts at a single window of the user interface.

5. The method of claim 1, further comprising generating one or more lists of codes based on the facility and professional reimbursement facts which are ready for subsequent-billing related processing.

6. The method of claim 1, wherein the selection input includes one or more of: additions or deletions to any of the determined facility or professional facts, changes to any of the determined the facility or professional facts, or an indication of no changes to the determined the facility or professional facts.

7. The method of claim 1, wherein determining the one or more facility reimbursement facts and determining the one or more professional reimbursement facts comprises determining the facility and professional reimbursement facts based on natural language processing of the patient encounter data.

8. The method of claim 1, further comprising automatically determining inconsistencies and inaccuracies between the determined facility and determined professional reimbursement facts, wherein automatically determining comprises comparing the determined facility and determined professional reimbursement facts to a set of pre-determined rules.

9. The method of claim 1, wherein the one or more facility reimbursement facts comprise at least one of an International Classification of Diseases (ICD) code, a Current Procedural Technology (CPT) code, or a Healthcare Common Procedural Coding System Code (HCPCS).

10. The method of claim 1, wherein the one or more professional reimbursement facts comprise at least one of an International Classification of Diseases (ICD) code, a Current Procedural Technology (CPT) code, or a Physician Quality Reporting System (PQRS) code.

11. The method of claim 1, further comprising determining, via the one or more computers, a value of a facility reimbursement based on the facility reimbursement facts.

12. The method of claim 1, further comprising determining, via the one or more computers, a value of a professional reimbursement based on the professional reimbursement facts.

13. A computerized medical system for processing medical data, the system comprising a computer that includes a processor and a memory, wherein the processor is configured to:
receive patient encounter data describing a patient encounter with a healthcare organization;
determine one or more facility reimbursement facts based on the patient encounter data;
determine one or more professional reimbursement facts based on the patient encounter data;
output a user interface including a listing of the determined facility reimbursement facts and a listing of the determined professional reimbursement facts;
receive selection input associated with the facility reimbursement facts and the professional reimbursement facts; and
receive an indication that the facility reimbursement facts and the professional reimbursement facts are ready for subsequent billing related processing.

14. The system of claim 13, wherein the processor is further configured to display the user interface at a display device.

15. The system of claim 13, wherein the processor is further configured to output the patient encounter data in the user interface.

16. The system of claim 13, wherein the processor is configured to receive the selection input associated with the facility reimbursement facts and the professional reimbursement facts at a single window of the user interface.

17. The system of claim 13, wherein the processor is configured to generate one or more lists of codes based on the facility and professional reimbursement facts which are ready for subsequent billing related processing.

18. The method of claim 13, wherein the selection input includes one or more of: additions or deletions to any of the determined facility or professional facts, changes to any of the determined the facility or professional facts, or an indication of no changes to the determined the facility or professional facts.

19. The system of claim 13, wherein the processor is further configured to determine the one or more facility reimbursement facts and to determine the one or more professional reimbursement facts based on natural language processing of the patient encounter data.

20. The method of claim 13, further comprising automatically determining inconsistencies and inaccuracies between the determined facility and determined professional reimbursement facts, wherein automatically determining comprises comparing the determined facility and determined professional reimbursement facts to a set of pre-determined rules.

21. The system of claim 13, wherein the one or more facility reimbursement facts comprise at least one of an International Classification of Diseases (ICD) code, a Current Procedural Technology (CPT) code, or a Healthcare Common Procedural Coding System Code (HCPCS).

22. The system of claim 13, wherein the one or more professional reimbursement facts comprise at least one of an International Classification of Diseases (ICD) code, a Current Procedural Technology (CPT) code, or a Physician Quality Reporting System (PQRS) code.

23. The system of claim 13, wherein the processor is further configured to determine a value of a facility reimbursement based on the facility reimbursement facts.

24. The system of claim 13, wherein the processor is further configured to determine a value of a professional reimbursement based on the professional reimbursement facts.

25. A device for processing medical data, the device comprising:
means for receiving patient encounter data describing a patient encounter with a healthcare organization;
means determining one or more facility reimbursement facts based on the patient encounter data;
means determining one or more professional reimbursement facts based on the patient encounter data;
means for outputting a user interface including a listing of the determined facility reimbursement facts and a listing of the determined professional reimbursement facts;
means for receiving selection input associated with the facility reimbursement facts and the professional reimbursement facts; and
means for receiving an indication that the facility reimbursement facts and the professional reimbursement facts are ready for subsequent billing related processing.

26. A computer readable storage medium comprising instructions that when executed in a processor cause the processor to process medical data, wherein upon execution the instructions cause the processor to:
receive patient encounter data describing a patient encounter with a healthcare organization;
determine one or more facility reimbursement facts based on the patient encounter data;
determine one or more professional reimbursement facts based on the patient encounter data;
output a user interface including a listing of the determined facility reimbursement facts and a listing of the determined professional reimbursement facts;
receive selection input associated with the facility reimbursement facts and the professional reimbursement facts; and
receive an indication that the facility reimbursement facts and the professional reimbursement facts are ready for subsequent billing related processing.
